(19) United States
(12) Patent Application Publication
(10) Pub. No.: US 2026/0206852 A1
(43) Pub. Date: Jul. 23, 2026

(54) HEATER ASSEMBLY WITH SEALING REGION

(71) Applicant: Philip Morris Products S.A., Neuchatel (CH)

(72) Inventors: Kyle Robert ADAIR, Forres (GB); Andrew Robert John ROGAN, Forres (GB)

(73) Assignee: Philip Morris Products S.A., Neuchatel (CH)

(21) Appl. No.: 19/137,891

(22) PCT Filed: Dec. 28, 2023
(86) PCT No.: PCT/EP2023/087915

§ 371 Date: Jun. 11, 2025

(30) Foreign Application Priority Data
Dec. 29, 2022 (EP) 22217168.8

(51) Int. Cl. A24F 40/44; A24F 40/10; A24F 40/42; A24F 40/46; A24F 40/70; H05B 3/06

(52) U.S. Cl. CPC A24F 40/44; A24F 40/10; A24F 40/42; A24F 40/46; A24F 40/70; H05B 3/06

(57) ABSTRACT

A heater assembly for an aerosol-generating device including a reservoir configured to hold a liquid aerosol-forming substrate is provided, the heater assembly including: a heating element; and an open-cell porous body coupled to the heating element, the open-cell porous body being configured to transport liquid from the reservoir towards the heating element, the open-cell porous body including a sealing region configured to restrict the flow of liquid from the reservoir through the open-cell porous body, and the open-cell porous body having a liquid absorption side and an aerosolization side, the heating element being disposed along the aerosolization side of the open-cell porous body and the sealing region being disposed along the liquid absorption side of the open-cell porous body such that a rate of liquid absorption through the open-cell porous body is limited.

The present disclosure relates to a heater assembly for an aerosol-generating system. In particular, but not exclusively, the present disclosure relates to a heater assembly for a handheld electrically operated aerosol-generating system for heating an aerosol-forming substrate to generate an aerosol and for delivering the aerosol into the mouth of a user. The present disclosure further relates to a cartridge and an aerosol-generating system comprising the heater assembly and also to a method of manufacturing a heater assembly.

Aerosol-generating systems that heat a liquid aerosol-forming substrate in order to generate an aerosol for delivery to a user are generally known in the prior art. These systems typically comprise an aerosol-generating device and a replaceable cartridge. The cartridge includes a liquid aerosol-forming substrate that is capable of releasing volatile compounds when heated. The cartridge typically also includes a heater for heating the liquid aerosol-forming substrate. In known aerosol-generating systems, the heater comprises a resistive heating element wound around a wick that supplies liquid aerosol-forming substrate to the heating element. The aerosol-generating device or cartridge also comprises a mouthpiece. When a negative pressure is applied at the mouthpiece, an electric current is passed through the heating element causing it to be heated by resistive or Joule heating, which, in turn, heats the liquid aerosol-forming substrate supplied by the wick. This causes volatile compounds to be released from the liquid aerosol-forming substrate that cool to form an aerosol. The aerosol is then drawn into a user's mouth via the mouthpiece.

Such known aerosol-generating systems have a number of drawbacks. For example, they can be difficult to manufacture with consistent manufacturing tolerances which can result in inconsistent vapour production and flavour generation. Inconsistent manufacturing tolerances can also affect the transfer of heat from the heating element to the wick reducing the energy efficiencies of such devices. A further problem encountered by such known aerosol-generating systems is “dry heating” or a “dry puff”, which arises when the heating element is heated with insufficient liquid aerosol-forming substrate being supplied to the heating element. This can occur, for example, when a user has consumed all of the liquid aerosol-forming substrate in the cartridge such that the cartridge is depleted of liquid aerosol-forming substrate and needs replacing. During operation, it is preferable to maintain a supply of liquid aerosol-forming substrate to the heating element such that the heating element is maintained in a wet state because this helps to ensure that a satisfactory aerosol is produced when a negative pressure is applied at the mouthpiece. Dry heating can result in overheating of the heating element and, potentially, thermal decomposition of the liquid aerosol-forming substrate, which can produce undesirable by-products and an unsatisfactory aerosol. Allowing the aerosol-generating system to continue to operate when liquid aerosol-forming substrate is not being supplied to the heating element can result in a poor user experience.

Some aerosol-generating systems comprise a cartridge utilising a heater assembly in the form of a ceramic atomizer core consisting of a heating element, electrical contacts and a ceramic atomizer body. The ceramic body is porous, and liquid aerosol-forming substrate is supplied from the cartridge's reservoir to the heating element via the open-cell pores present within the ceramic atomizer body. The pores in the ceramic atomizer body must be large enough to enable a sufficient flow of liquid through to the heating element and to enable the ceramic atomizer body to have a sufficient liquid retention capacity to prevent a “dry burn”, “dry heating” or “dry puff” situation, which can lead to the release of undesirable by-products, an unsatisfactory aerosol, and a poor user experience. However, having too large a pore size in the ceramic atomizer body can have the undesirable effect of too much liquid being supplied to the heater surface leading to liquid leakage from the aerosol-generating system. To address this problem, some aerosol-generating systems utilise an additional fluid communication channel(s) between the liquid aerosol-forming substrate reservoir and the porous ceramic atomizer body. In this way the size and number of the fluid communication channels control the rate at which liquid aerosol-forming substrate can flow to the ceramic atomizer body and subsequently through the ceramic pores to the heater surface. Such solutions, however, can add additional size, complexity and cost to the aerosol-generating system due to the reliance on the use of additional components to create the fluid communication channels.

It would be desirable to provide a heater assembly capable of generating a more consistent aerosol. It would be desirable to provide a heater assembly that reduces the likelihood of a user experiencing liquid leakage during use of the aerosol-generating system. It would be desirable to provide a heater assembly that reduces the likelihood of a user experiencing dry heating or a dry puff and that restricts a user from being able to continue to use an aerosol-generating system when liquid aerosol-forming substrate is not being supplied to the heating element.

According to an example of the present disclosure, there is provided a heater assembly for an aerosol-generating system comprising a reservoir for holding a liquid aerosol-forming substrate. The heater assembly may comprise a heating element for heating a liquid aerosol-forming substrate to form an aerosol. The heater assembly may comprise an open-cell porous body for supplying the liquid aerosol-forming substrate to the heating element. The open-cell porous body may comprise a sealing region configured to restrict the flow of liquid aerosol-forming substrate from the reservoir through open-cell porous body.

According to an example of the present disclosure, there is provided a heater assembly for an aerosol-generating system comprising a reservoir for holding a liquid aerosol-forming substrate. The heater assembly comprises a heating element for heating a liquid aerosol-forming substrate to form an aerosol. The heater assembly comprises an open-cell porous body for supplying the liquid aerosol-forming substrate to the heating element. The open-cell porous body comprises a sealing region configured to restrict the flow of liquid aerosol-forming substrate from the reservoir through open-cell porous body.

Advantageously, the provision of a sealing region on or within the open-cell porous body enables the rate at which liquid aerosol-forming substrate is delivered from the reservoir to the heater element to be controlled, without reliance on additional components between the reservoir and the open-cell porous body for controlling the flow of liquid aerosol-forming substrate onto the open-cell porous body. Furthermore, manufacturing an open-cell porous body having a pore size which is optimised for a specific aerosol-generating system in order to minimise the risk of dry-burn and liquid leakage may be difficult. The proposed heater assembly solution may be manufactured easily by first forming an open-cell porous body having relatively large pore sizes, which can then be selectively sealed based on the specific aerosol-generating system (e.g., based on the area of the open-cell porous body exposed to the liquid, the viscosity of the liquid aerosol-forming substrate in the reservoir and the operating temperatures of the aerosol-generating system).

As used herein, the term “aerosol-generating device” relates to a device that interacts with a liquid aerosol-forming substrate to generate an aerosol.

As used herein, the terms “cartridge” and “aerosol-generating cartridge” relate to a component that interacts with a liquid aerosol-forming device to generate an aerosol. An aerosol-generating cartridge contains, or is configured to contain, a liquid aerosol-forming substrate.

As used herein, the term “liquid aerosol-forming substrate” relates to a liquid substrate capable of releasing volatile compounds that can form an aerosol. Such volatile compounds can be released by heating the aerosol-forming substrate.

As used herein, the term “heating element” refers to a component which transfers heat energy to the liquid aerosol-forming substrate. It will be appreciated that the heating element may be deposited directly on the open-cell porous body.

As used herein, the term “open-cell porous body” refers to a component which has a plurality of pores, at least some of which are interconnected. The open-cell porous body is configured to contain liquid within the plurality of pores.

As used herein, the term “sufficient” when used in the phrase “sufficient amount of liquid aerosol-forming substrate” refers to an amount of aerosol-forming substrate which, when present at the heating element, prevents a dry heating or a dry puff situation.

As used herein, the term “sealing region” refers to a region of the open-cell porous body that is liquid impermeable such that the flow of liquid through the sealing region is prevented.

The open-cell porous body may define a series of capillaries. The open-cell porous body may have a liquid absorption side and an aerosolization side. The heating element may be disposed along the aerosolization side of the open-cell porous body. The open-cell porous body may be configured to supply liquid aerosol-forming substrate from the liquid absorption side to the aerosolization side of the open-cell porous body. The sealing region may be disposed along the liquid absorption side of the open-cell porous body in order to limit the rate of liquid absorption through the open-cell porous body.

The open-cell porous body may be a ceramic body. Alternatively, the open-cell porous body may be one of a glass, plastic or metal body. The open-cell porous body may have a porosity of between 30-70%.

In other examples, the sealing region may be porous. In such examples, the sealing region may have a porosity which is lower than the porosity of the open-cell porous body to prevent the flow of liquid into the open-cell porous body through the sealing region.

The sealing region may be formed across an outermost surface of the open-cell porous body. By restricting the flow of liquid through the open-cell porous body at the outermost surface, the liquid retention capacity of the open-cell porous body may be maintained while limiting the maximum liquid flow rate into the open-cell porous body. Liquid aerosol-forming substrate retained within open-cell porous body can function as a buffer in the event of disruption between the flow of liquid aerosol-forming substrate between the reservoir and the open-cell porous body. The heater assemblies of the present disclosure may therefore avoid both dry burn and liquid leakage in an aerosol-generating system.

The sealing region may extend across a majority of a face of the open-cell porous body. For example, the sealing region may cover more than 50% of the face of the open-cell porous body. In one example, the sealing region may extend across the entirety of the face of the open-cell porous body. Providing the sealing region which extends across a larger surface of the open-cell porous body may improve the extent to which the liquid flow rate into the open-cell porous body is restricted.

In an example, the sealing region may extend continuously across the face of the open-cell porous body, thereby restricting the flow of liquid into the open-cell porous body through the face in a uniform manner. In an another example, the sealing region may extend intermittently across the face of the open-cell porous body creating regions of restricting and unrestricted flow of liquid into the open-cell porous body.

In one example, the sealing region may at least partially extend into the pores of the open-cell porous body. In some examples, the sealing region extends from an outer surface of the open-cell porous body into the outmost pores of the open-cell porous body. In some examples, the sealing region extends into pores of the open-cell porous body to completely block the flow of liquid through the pores. In other examples, the sealing region extends into pores of the open-cell porous body partially blocking the pores, thereby reducing the effective size of the pores, and consequently, the rate at which liquid can flow through the pores.

In an example, the sealing region may have a thickness greater than 10 μm. In an example, the sealing region may have a thickness smaller than 1 mm.

The sealing region may comprise an inorganic layer. The inorganic layer may be deposited across the outer most pores of the open-cell porous body. The inorganic layer may comprise one of Aluminium Oxide, Silicon Oxide, Magnesium Oxide, Barium Oxide, Calcium Oxide, Zirconium Dioxide or Zinc Oxide.

In an example, the sealing region may comprise a region in which the outermost pores of the open-cell porous body are deformed to prevent the flow of liquid through the pores into the open-cell porous body. Such examples may be particularly advantageous in that they do not require any additional materials, but rather rely on modification of the manufactured open-cell porous body.

In an example, the sealing region may comprise one or more melted portions of the outer face of the open-cell porous body. In such examples, the sealing region may comprise outermost pores of the open-cell porous body which are deformed in a way that prevents the flow of liquid through the pores into the open-cell porous body.

In an example, the heating element may be coupled to a first face of the open-cell porous body. The sealing region may extend across at least one other face of the open-cell porous body. The at least one other face may include a face opposite the first face. In another example, the at least one other face may include a face adjacent to the first face. The open-cell porous body may have a cuboidal shape. In some examples, the at least one other face may comprise each of the faces adjacent to the first face. In some examples, the sealing region may extend across all remaining faces (e.g., for a cuboidal open-cell porous body, each of the side faces and the bottom face) of the open-cell porous body. In some examples, the sealing region may cover each of the remaining faces of the open-cell porous body.

It will be appreciated that alternative open-cell porous body shapes may be used, and that the location of the sealing region(s) may be modified according to the shape of the open-cell porous body to effectively restrict the flow of liquid aerosol-forming substrate into the open-cell porous body.

The liquid aerosol-forming substrate may be liquid at room temperature. The liquid aerosol-forming substrate may comprise both liquid and solid components. The liquid aerosol-forming substrate may comprise nicotine. The nicotine containing liquid aerosol-forming substrate may be a nicotine salt matrix. The liquid aerosol-forming substrate may comprise plant-based material. The liquid aerosol-forming substrate may comprise tobacco. The liquid aerosol-forming substrate may comprise a tobacco-containing material containing volatile tobacco flavour compounds, which are released from the aerosol-forming substrate upon heating. The liquid aerosol-forming substrate may comprise homogenised tobacco material. The liquid aerosol-forming substrate may comprise a non-tobacco-containing material. The liquid aerosol-forming substrate may comprise homogenised plant-based material.

The liquid aerosol-forming substrate may comprise one or more aerosol-formers. An aerosol-former is any suitable known compound or mixture of compounds that, in use, facilitates formation of a dense and stable aerosol and that is substantially resistant to thermal degradation at the temperature of operation of the system. Examples of suitable aerosol formers include glycerine and propylene glycol. Suitable aerosol-formers are well known in the art and include, but are not limited to: polyhydric alcohols, such as triethylene glycol, 1,3-butanediol and glycerine; esters of polyhydric alcohols, such as glycerol mono-, di- or triacetate; and aliphatic esters of mono-, di- or polycarboxylic acids, such as dimethyl dodecanedioate and dimethyl tetradecanedioate. The liquid aerosol-forming substrate may comprise water, solvents, ethanol, plant extracts and natural or artificial flavours.

The liquid aerosol-forming substrate may comprise nicotine and at least one aerosol-former. The aerosol-former may be glycerine or propylene glycol. The aerosol former may comprise both glycerine and propylene glycol. The liquid aerosol-forming substrate may have a nicotine concentration of between about 0.5% and about 10%, for example about 2%.

The heating element may be arranged along a porous outer surface of the open-cell porous body. The porous outer surface on which the heating element is disposed may be substantially flat. The heating element may at least partially extend into pores of the porous outer surface. The heater assembly may comprise a protection layer. The protection layer may be arranged to extend across at least a portion of the heating element to protect the heating element.

The heating element may be electrically connected to electrical contacts. The heating element may be configured to heat the liquid aerosol-forming substrate upon application of an electrical potential difference to the electrical contacts. The heating element may be one or more of a curvilinear or a serpentine shape. The heating element may comprise an electrically resistive heating element. The heating element may be made from any suitable electrically conductive material. Suitable materials include but are not limited to: semiconductors such as doped ceramics, electrically “conductive” ceramics (such as, for example, molybdenum disilicide), carbon, graphite, metals, metal alloys and composite materials made of a ceramic material and a metallic material. Such composite materials may comprise doped or undoped ceramics. Examples of suitable doped ceramics include doped silicon carbides. Examples of suitable metals include titanium, zirconium, tantalum and metals from the platinum group. Examples of suitable metal alloys include stainless steel, constantan, nickel-, cobalt-, chromium-, aluminum-, titanium-, zirconium-, hafnium-, niobium-, molybdenum-, tantalum-, tungsten-, tin-, gallium-, manganese- and iron-containing alloys, and super-alloys based on nickel, iron, cobalt, stainless steel, Timetal®, iron-aluminum based alloys and iron-manganese-aluminum based alloys. Timetal® is a registered trade mark of Titanium Metals Corporation. The heating element may be made from stainless steel, for example, a 300 series stainless steel such as AISI 304, 316, 304L, 316L.

Additionally, the heating element may comprise combinations of the above materials. A combination of materials may be used to improve the control of the resistance of the heating element. For example, materials with a high intrinsic resistance may be combined with materials with a low intrinsic resistance. This may be advantageous if one of the materials is more beneficial from other perspectives, for example price, machinability or other physical and chemical parameters. Advantageously, high resistivity heating allow more efficient use of battery energy.

According to an example of the present disclosure, there is provided a cartridge for an aerosol-generating system. The cartridge may comprise the heater assembly. The cartridge may comprise a liquid storage portion configured to hold a liquid aerosol-forming substrate. The liquid storage portion may be arranged to deliver liquid aerosol-forming substrate to an opposite side of the heater assembly to the heating element.

According to an example of the present disclosure, there is provided a cartridge for an aerosol-generating system. The cartridge comprises a heater assembly. The cartridge comprises a liquid storage portion configured to hold a liquid aerosol-forming substrate. The liquid storage portion is arranged to deliver liquid aerosol-forming substrate to an opposite side of the heater assembly to the heating element.

According to an example of the present disclosure, there is provided an aerosol-generating system. The aerosol-generating system may comprise the cartridge. The aerosol-generating system may comprise an aerosol-generating device having a power supply for supplying electrical power to the heating element. The aerosol-generating device may comprise control circuitry configured to control a supply of power from the power supply to the heating element.

According to an example of the present disclosure, there is provided an aerosol-generating system. The aerosol-generating system comprises the cartridge. The aerosol-generating system comprises an aerosol-generating device having a power supply for supplying electrical power to the heating element. The aerosol-generating device comprises control circuitry configured to control a supply of power from the power supply to the heating element.

According to an example of the present disclosure, there is provided a method for manufacturing a heater assembly for an aerosol-generating system comprising a reservoir for holding a liquid aerosol-forming substrate. The heater assembly may comprise a heating element coupled to an open-cell porous body. The method may comprise applying a sealing region on a face of the open-cell porous body for restricting the flow of liquid from the reservoir through the open-cell porous body.

According to an example of the present disclosure, there is provided a method for manufacturing a heater assembly for an aerosol-generating system comprising a reservoir for holding a liquid aerosol-forming substrate. The heater assembly comprises a heating element coupled to an open-cell porous body. The method comprises applying a sealing region on a face of the open-cell porous body for restricting the flow of liquid from the reservoir through the open-cell porous body.

In some examples, the sealing region may be applied by spraying a slurry of precursor material onto the face of the open-cell porous body. The slurry may then undergo a sintering process to form a sealing layer across the open-cell porous body. In some examples, the precursor material may comprise a silicate material.

In some examples, the sealing region may be applied on the open-cell porous body via physical vapor deposition. In other examples, the sealing region may be applied on the open-cell porous body via chemical vapor deposition. In some examples, after depositing a sealing material on the open-cell porous body, the outer surface of the open-cell porous body may be wiped clean such that sealing material only remains within the pores of the open-cell porous body.

In some examples, the sealing region may be applied on the open-cell porous material by melting the surface of the open-cell porous body with a laser (or other heating device) to deform the outermost pores in the open-cell porous body.

In some examples, the method may comprise shielding areas of the face of the open-cell porous body while applying the sealing region on the open-cell porous body to maintain one or more regions on the open-cell porous body.

In some examples where the heating element is coupled to a first face of the open-cell porous body, the method may comprise applying the sealing region across at least one other face of the open-cell porous body. The at least one other face may include a face opposite the first face.

In other examples where the heating element is coupled to a first face of the open-cell porous body, the method may comprise applying the sealing region across at least one other face of the open-cell porous body. The at least one other face may include a face adjacent to the first face. In some examples, the at least one other face may comprise each of the faces adjacent to the first face. In other examples, the at least one other face may comprise the remaining faces of the open-cell porous body.

In some examples, the sealing region may be applied across a majority of the face of the open-cell porous body. In some examples, the sealing region may be applied across the entirety of the face of the open-cell porous body.

In some examples, the sealing region is applied on the open-cell porous body having a thickness greater than 10 μm.

In some examples, the sealing region may comprise an inorganic layer applied across the outer most pores of the open-cell porous body. In some examples, the inorganic layer comprises one of Aluminium Oxide, Silicon Oxide, Magnesium Oxide, Barium Oxide, Calcium Oxide, Zirconium Dioxide or Zinc Oxide.

The open-cell porous body may have been manufactured by sintering. The open-cell porous body may have been manufactured by directly sintering a ceramic powder, to form an open-cell porous body having pores between interconnected powder particles. The open-cell porous body may have been manufactured by using a sacrificial material within a ceramic powder, the sacrificial material being used as a spacer to form pores. The sacrificial material may have been burnt off during sintering.

The aerosol-generating system may be portable. The aerosol-generating system may have a size comparable to a conventional cigar or cigarette.

The aerosol-generating device may contain control circuitry. The control circuitry may comprise any suitable controller or electrical components. The controller may comprise a memory. Information for performing the above-described method may be stored in the memory. The control circuitry may comprise a microprocessor. The microprocessor may be a programmable microprocessor, a microcontroller, or an application specific integrated chip (ASIC) or other electronic circuitry capable of providing control. The control circuitry may be configured to supply power to the heating element continuously following activation of the device, or may be configured to supply power intermittently, such as on a puff-by-puff basis. The power may be supplied to the heating element in the form of pulses of electrical current, for example, by means of pulse width modulation (PWM). The control circuitry may comprise further electronic components. For example, in some embodiments, the control circuitry may comprise any of: sensors, switches, display elements.

The aerosol-generating device may contain a power supply in the form of a battery. The battery may be rechargeable. The battery may be a Lithium based battery, for example a Lithium-Cobalt, a Lithium-Iron-Phosphate, a Lithium Titanate or a Lithium-Polymer battery. The battery may be a Nickel-metal hydride battery or a Nickel cadmium battery. The power supply may be another form of charge storage device such as a capacitor. The power supply may be rechargeable and be configured for many cycles of charge and discharge. The power supply may have a capacity that allows for the storage of enough energy for one or more user experiences of the aerosol-generating system; for example, the power supply may have sufficient capacity to allow for the continuous generation of aerosol for a period of around six minutes, corresponding to the typical time taken to smoke a conventional cigarette, or for a period that is a multiple of six minutes. In another example, the power supply may have sufficient capacity to allow for a predetermined number of puffs or discrete activations of the aerosol-generating system.

The aerosol-generating device may comprise a housing. The housing may be elongate. The housing may comprise any suitable material or combination of materials. Examples of suitable materials include metals, alloys, plastics or composite materials containing one or more of those materials, or thermoplastics that are suitable for food or pharmaceutical applications, for example polypropylene, polyetheretherketone (PEEK) and polyethylene. The material is preferably light and non-brittle.

The cartridge may be releasably couplable to the aerosol-generating device.

The cartridge of the aerosol-generating system may have a connection end. At the connection end, the cartridge may be connected to or connectable to the aerosol-generating device. The connection end of the cartridge may have electrical contacts which are electrically connectable to electrical contacts on the aerosol-generating device. The cartridge may comprise one or more of: a mouthpiece, a cartridge body, an external air inlet, an internal air passage and an aerosol outlet.

The mouthpiece may be connected to or connectable to the cartridge body. The mouthpiece may be connected to or connectable to the cartridge body so as to define one or more external air inlets between the mouthpiece and the cartridge body. The mouthpiece may be arranged at an end of the cartridge body. The mouthpiece may be arranged at an end of the cartridge body opposite to the connection end. The mouthpiece may comprise the aerosol outlet. The cartridge body may comprise the heater assembly. The cartridge body may comprise the liquid storage portion. The heater assembly may be disposed proximate to or at the connection end. The liquid storage portion may be disposed between the heater assembly and the mouthpiece.

The liquid storage portion may be disposed at a first side of the heater assembly. An airflow channel may be disposed at an opposite side of the heater assembly to the first side. The airflow channel may be adjacent to the heating element. An airflow path may extend past the heating element. The airflow path may be configured to convey the aerosol. The cartridge body may be configured such that air flow past the heater assembly entrains vapourised aerosol-forming substrate. The cartridge may be configured such that air can flow from external to the system, through external air inlets and within the cartridge body. The cartridge may be configured so that air can then flow towards the connection end. At the connection end, air may be guided to turn back on itself to flow through a centre of the cartridge. In doing this, airflow may pass the heater assembly. At the heater assembly, air may be combined with aerosol. The cartridge may be configured such that after being combined with aerosol, airflow passes through the centre of the cartridge to the mouthpiece. Airflow may then pass out of the aerosol outlet aperture.

The mouthpiece may include internal baffles. The internal baffles may be integrally moulded with the external walls of the mouthpiece portion. The baffles may ensure that, as air is drawn from inlets to the aerosol outlet aperture, it flows over the heater assembly on the cartridge where aerosol-forming substrate is being vapourised. As the air passes the heater assembly, vapourised substrate may be entrained in the airflow, and may cool to form an aerosol before exiting the aerosol outlet aperture.

Features described in relation to one of the above examples may equally be applied to other examples of the present disclosure.

The invention is defined in the claims. However, below there is provided a non-exhaustive list of non-limiting examples. Any one or more of the features of these examples may be combined with any one or more features of another example, embodiment, or aspect described herein.

Example Ex1: A heater assembly for an aerosol-generating device comprising a reservoir for holding a liquid aerosol-forming substrate, the heater assembly comprising:
a heating element; and
an open-cell porous body coupled to the heating element, wherein the open-cell porous body is configured to transport liquid from the reservoir towards the heating element;
wherein the open-cell porous body comprises a sealing region configured to restrict the flow of liquid from the reservoir through the open-cell porous body.

Example Ex2: A heater assembly according to any preceding Ex, wherein the sealing region extends across a majority of the face of the open-cell porous body.

Example Ex3: A heater assembly according to any preceding Ex, wherein the sealing region extends across the entirety of the face of the open-cell porous body.

Example Ex4: A heater assembly according to any preceding Ex, wherein the sealing region has a thickness greater than 10um.

Example Ex5: A heater assembly according to any preceding Ex, wherein the open-cell porous body comprises one of a ceramic, glass, plastic or metal body.

Example Ex6: A heater assembly according to any preceding Ex, wherein the open-cell porous body has a porosity of between 30-70%.

Example Ex7: A heater assembly according to any preceding Ex, wherein the sealing region comprises an inorganic layer deposited across the outer most pores of the open-cell porous body, wherein the inorganic layer comprises one of Aluminium Oxide, Silicon Oxide, Magnesium Oxide, Barium Oxide, Calcium Oxide, Zirconium Dioxide or Zinc Oxide.

Example Ex8: A heater assembly according to any of preceding Ex, wherein the open-cell porous body comprises a sintered ceramic material.

Example Ex9: A heater assembly according to any of preceding Ex, wherein the heating element is electrically connected to electrical contacts.

Example Ex10: A heater assembly according to Ex9, wherein the heating element is configured to heat the liquid aerosol-forming substrate upon application of an electrical potential difference to the electrical contacts.

Example Ex11: A cartridge for an aerosol-generating system, comprising:
the heater assembly of any preceding Ex; and
a liquid storage portion configured to hold a liquid aerosol-forming substrate.

Example Ex12: An aerosol-generating system, comprising:
the cartridge of Example Ex11; and
an aerosol-generating device.

Example Ex13: A method for manufacturing a heater assembly for an aerosol-generating device comprising a reservoir for holding a liquid aerosol-forming substrate, wherein the heater assembly comprises a heating element coupled to an open-cell porous body, the method comprising:
applying a sealing region across a face of the open-cell porous body for restricting the flow of liquid from the reservoir through the open-cell porous body.

Example Ex14: A method according to Ex13, wherein applying the sealing region comprises:
spraying a slurry of precursor material onto the face of the open-cell porous body; and
sintering the slurry to form a sealing layer across the open-cell porous body.

Example Ex15: A method according to any of Ex13 to Ex14, wherein the precursor material comprises a silicate material.

Example Ex16: A method according to any of Ex13, wherein applying the sealing region comprises physical vapor deposition.

Example Ex17: A method according to any of Ex13, wherein applying the sealing region comprises chemical vapor deposition.

Example Ex18: A method according to any of Ex13, wherein applying the sealing region comprises melting the outer face of the open-cell porous body to cause deformation of the outermost pores.

Example Ex19: A method according to any of Ex13 to Ex18, wherein the method comprises shielding areas of the face of the open-cell porous body while applying the sealing region.

Example Ex20: A method according to any of Ex13 to Ex19, wherein the heating element is coupled to a first face of the open-cell porous body, wherein the method comprises:
applying the sealing region across at least one other face of the open-cell porous body, wherein the at least one other face includes a face opposite the first face.

Example Ex21: A method according to any of Ex13 to Ex20, wherein the heating element is coupled to a first face of the open-cell porous body, wherein the method comprises:
applying the sealing region across at least one other face of the open-cell porous body, wherein the at least one other face includes a face adjacent to the first face.

Example Ex22: A method according to any of Ex21, wherein the open-cell porous body has a cuboidal shape, and wherein the at least one other face comprises of each of the faces adjacent to the first face.

Example Ex23: A method according to any of Ex13 to Ex22, wherein the heating element is coupled to a first face of the open-cell porous body and the sealing region is provided across the remaining faces of the open-cell porous body.

Example Ex24: A method according to any of Ex13 to Ex23, wherein the sealing region extends across a majority of the face of the open-cell porous body.

Example Ex25: A method according to any of Ex13 to Ex24, wherein the sealing region extends across the entirety of the face of the open-cell porous body.

Example Ex26: A method according to any of Ex13 to Ex25, wherein the sealing region extends continuously across the face of the open-cell porous body.

Example Ex27: A method according to any of Ex13 to Ex25, wherein the sealing region extends intermittently across the face of the open-cell porous body.

Example Ex28: A method according to any of Ex13 to Ex27, wherein the sealing region at least partially extends into pores of the open-cell porous body.

Example Ex29: A method according to any of Ex13 to Ex27, wherein the sealing region is porous and has a porosity which is lower than the porosity of the open-cell porous body.

Example Ex30: A method according to any of Ex13 to Ex29, wherein the sealing region has a thickness greater than 10 μm.

Example EX31: A method according to any of Ex13 to Ex30, wherein the sealing region has a maximum thickness of 1 mm.

Example Ex32: A method according to any of Ex13 to Ex31, wherein the sealing region comprises an inorganic layer deposited across the outer most pores of the open-cell porous body. Example Ex33: A method according to Ex32, wherein the inorganic layer comprises one of Aluminium Oxide, Silicon Oxide, Magnesium Oxide, Barium Oxide, Calcium Oxide, Zirconium Dioxide or Zinc Oxide.

Example Ex34: A method according to any of Ex13 to Ex33, wherein the open-cell porous body comprises one of a ceramic, glass, plastic or metal body.

Example Ex35: A method according to any of Ex13 to Ex34, wherein the open-cell porous body has a porosity of between 30-70%.

Examples will now be further described with reference to the figures in which:

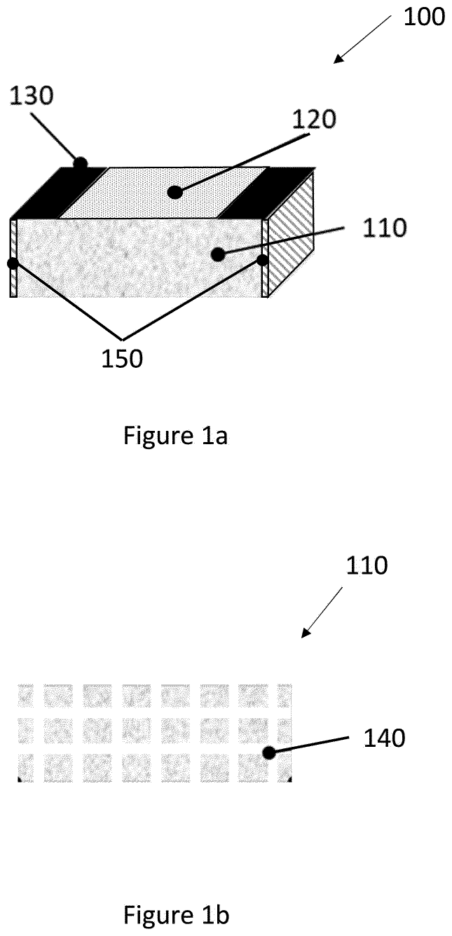

FIG. 1a is an isometric illustration of a heater assembly in accordance with an example of the present disclosure;

FIG. 1b is a schematic illustration of an open-cell porous body in accordance with an example of the present disclosure;

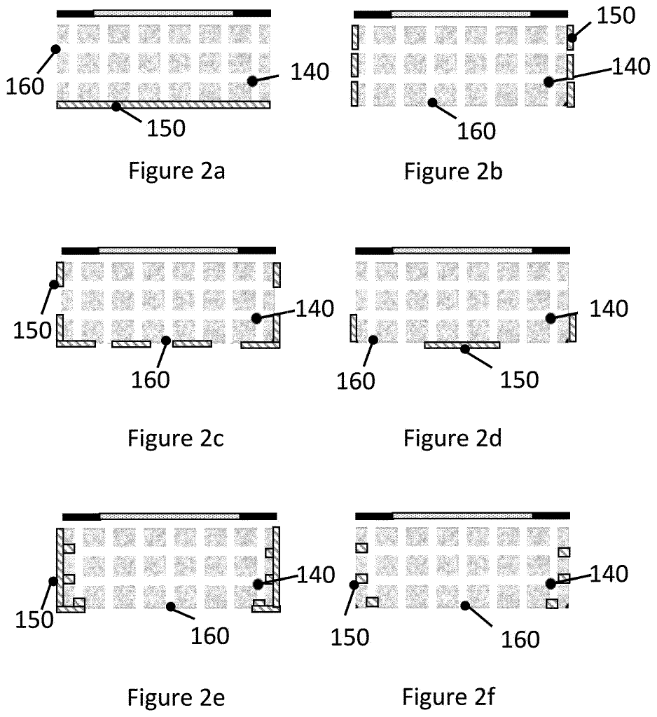

FIG. 2a is a schematic illustration of a heater assembly in accordance with an example of the present disclosure comprising a sealed region on a face of an open-cell porous body opposing a face comprising a heating element;

FIG. 2b is a schematic illustration of a heater assembly in accordance with an example of the present disclosure comprising intermittent sealing regions along the side faces of an open-cell porous body;

FIG. 2c is a schematic illustration of a heater assembly in accordance with an example of the present disclosure comprising intermittent sealing regions around the side and bottom faces of an open-cell porous body;

FIG. 2d is a schematic illustration of a heater assembly in accordance with an example of the present disclosure comprising sealing regions extending along portions of each of the side and bottom faces of an open-cell porous body;

FIG. 2e is a schematic illustration of a heater assembly in accordance with an example of the present disclosure comprising a sealing region extending at least partially into the pores of an open-cell porous body;

FIG. 2f is a schematic illustration of a heater assembly in accordance with an example of the present disclosure comprising sealing region in the pores in an open-cell porous body;

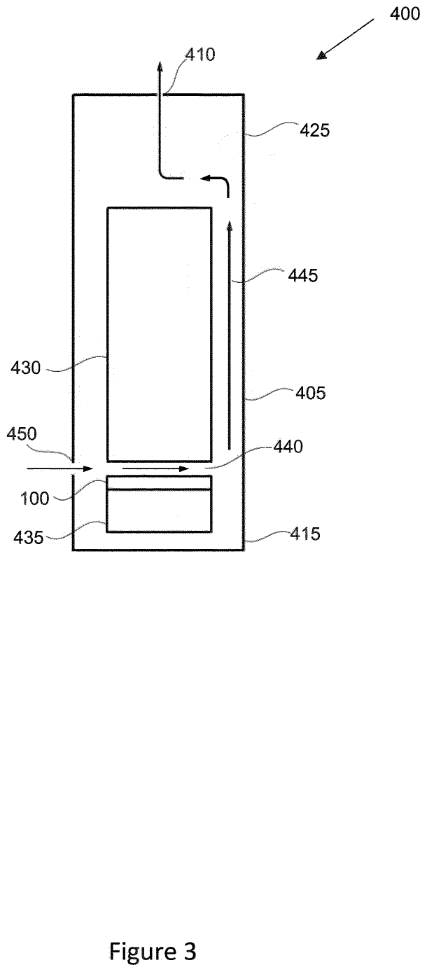

FIG. 3 is a schematic illustration of a cartridge having a heater assembly in accordance with an example of the present disclosure;

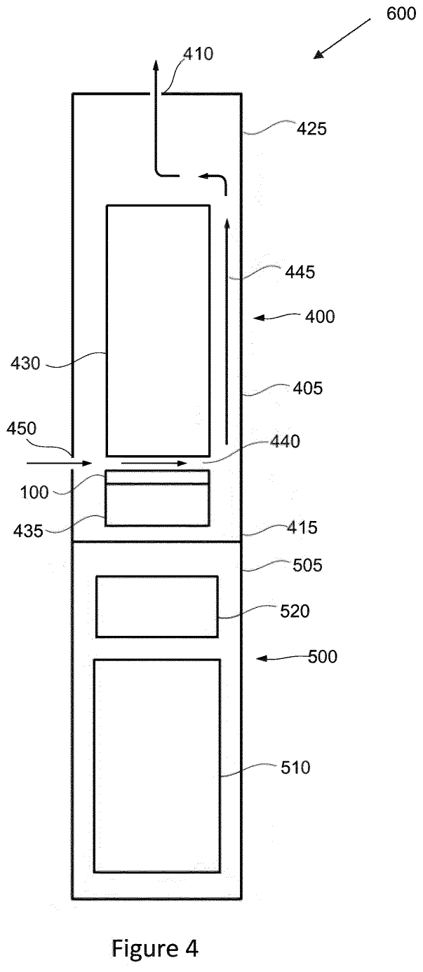

FIG. 4 is a schematic illustration of an aerosol-generating system in accordance with an example of the present disclosure; and

The above and other features and advantages of example embodiments will become more apparent by describing in detail, example embodiments with reference to the attached drawings. However, specific structural and functional details disclosed herein are merely representative for purposes of describing example embodiments. Example embodiments may, however, be embodied in many alternate forms and should not be construed as limited to only the embodiments set forth herein.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but to the contrary, example embodiments are to cover all modifications, equivalents, and alternatives falling within the scope of example embodiments. Like numbers refer to like elements throughout the description of the figures.

Spatially relative terms (for example, “below”) may be used herein for ease of description to describe one element or feature's relationship to another element or feature as illustrated in the figures. It should be understood that the spatially relative terms are intended to encompass different orientations of the device in use or operation in addition to the orientation depicted in the figures. For example, if the device in the figures is turned over, elements described as “below” other elements or features would then be oriented “above” the other elements or features. Therefore, the term “below” may encompass both an orientation of above and below. The device may be otherwise oriented (rotated 90 degrees or at other orientations) and the spatially relative descriptors used herein interpreted accordingly.

It should be understood that when an element or layer is referred to as being “disposed on”, another element or layer, it may be directly on, connected to, coupled to, or covering the other element or layer, or intervening elements or layers may be present. In contrast, when an element is referred to as being “directly disposed on” another element or layer, there are no intervening elements or layers present.

The terminology used herein is for the purpose of describing various embodiments only and is not intended to be limiting of example embodiments. As used herein, the singular forms “a,” “an,” and “the” are intended to include the plural forms as well, unless the context clearly indicates otherwise. It will be further understood that the terms “includes,” “including,” “comprises,” and “comprising,” when used in this specification, specify the presence of stated features, integers, steps, operations or elements, but do not preclude the presence or addition of one or more other features, integers, steps, operations, elements or groups thereof.

Example embodiments are described herein with reference to cross-sectional illustrations that are schematic illustrations of idealized embodiments (and intermediate structures) of example embodiments. As such, variations from the shapes of the illustrations as a result, for example, of manufacturing techniques or tolerances, are to be expected. Therefore, example embodiments should not be construed as limited to the shapes of regions illustrated herein but are to include deviations in shapes that result, for example, from manufacturing. Therefore, the regions illustrated in the figures are schematic in nature and their shapes are not intended to illustrate the actual shape of a region of a device and are not intended to limit the scope of example embodiments. The same reference numerals represent the same elements throughout the drawings. The accompanying drawings are not to be considered as drawn to scale unless explicitly noted. It will be appreciated that the figures in the application are schematic, and that some features have been omitted for the sake of clarity.

Unless otherwise defined, all terms (including technical and scientific terms) used herein have the same meaning as commonly understood by one of ordinary skill in the art to which example embodiments belong. It will be further understood that terms, including those defined in commonly used dictionaries, should be interpreted as having a meaning that is consistent with their meaning in the context of the relevant art and will not be interpreted in an idealized or overly formal sense unless expressly so defined herein.

The accompanying drawings are intended to depict example embodiments and should not be interpreted to limit the intended scope of the claims.

Referring to FIG. 1a, there is shown a schematic illustration of a heater assembly 100 for an aerosol-generating system, in accordance with an example of the present disclosure. The heater assembly 100 comprises: an open-cell porous body 110, an heating element 120, electrical contacts 130, and a sealing region 150 applied to the sides of the open-cell porous body 110.

The open-cell porous body 110 is configured to supply liquid aerosol-forming substrate to the heating element 120. Specifically, the open-cell porous body 110 is configured to transmit liquid aerosol-forming substrate from a liquid reservoir (not shown in FIG. 1 for clarity) to the heating element 120. The open-cell porous body 110 is configured to store some liquid aerosol-forming substrate until it is aerosolized by the heating element 120.

As illustrated in FIG. 1b, the open-cell porous body 110 is a rectangular block. The open-cell porous body 110 comprises a plurality pores 140. The plurality of open-cell pores 140 are interconnected to provide a fluid pathway for aerosol-generating liquid through the open-cell porous body 110. The open-cell porous body 110 comprises a material which does not chemically interact with the liquid aerosol-forming substrate. The open-cell porous body 110 comprises ceramic. The open-cell porous body 110 comprises Ca₂SiO₃ or SiO₂ (or Ca₂SiO₃ and SiO₂). It will be appreciated that the open-cell porous body 110 may have a different shape or comprise a different material. In other embodiments, the open-cell porous body 110 comprises one of glass, plastic or metal.

The heating element 120 is provided across a top face of the open-cell porous body 110. The electric heating element 120 is configured to heat a liquid aerosol-forming substrate to form an aerosol. The heating element 120 is configured to convert electrical energy into heat energy by material resistance of the heating element 120 to an electrical current.

The heating element 120 is elongate. The heating element 120 comprises NiCr or TiZr (or NiCr and TiZr). It will be appreciated that the heating element 120 may have a different shape or comprise a different material.

The heating element 120 is arranged along a porous outer surface of the open-cell porous body 110. The heating element 120 is in direct contact with the open-cell porous body 110. The heating element 120 is disposed on a single surface of the open-cell porous body 110.

The heating element 120 is electrically connected to electrical contacts 130. The heating element 120 is configured to heat the liquid aerosol-forming substrate upon application of an electrical potential difference to the electrical contacts 130. The electrical contacts 130 are disposed at each end of the elongate heating element 120. The electrical contacts 130 are directly disposed on the same surface of the open-cell porous body 110 as the heating element 120. The electrical contacts 130 comprise CuZnAu. The electrical contacts 130 are disposed at opposite edges of the porous outer surface of the open-cell porous body 110. The electrical contacts 130 are aligned with opposite edges of the porous outer surface of the open-cell porous body 110.

The sealing region 150 extends continuously across the side faces of the open-cell porous body 110 adjacent to the face comprising the heating element 120. Sealing region 150 is configured to restrict the flow of liquid through the open-cell porous body 110 to the heating element 120. In the embodiment of FIG. 1a, the flow of liquid through the side faces of the open-cell porous body 110 is prevented while the flow of liquid through the bottom face of the open-cell porous body is unrestricted.

FIGS. 2a-f, illustrate heater assembly 100 embodiments having alternative sealing region arrangements. FIG. 2a illustrates an embodiment in which the sealing region 150 extends continuously across the bottom face of the open-cell porous body 110, opposing the face comprising the heating element 120. FIG. 2b illustrates an embodiment in which the sealing region 150 extends intermittently across the side faces of the open-cell porous body 110 adjacent to the face comprising the heating element 120. FIG. 2c illustrates an embodiment in which the sealing region 150 extends intermittently across the side and bottom faces of the open-cell porous body 110, thereby restricting the flow of liquid through both the side and bottom faces of the open-cell porous body 110. FIG. 2d illustrates an embodiment in which the sealing region 150 extends across a portion (but not the entirety) of the side and bottom faces of the open-cell porous body 110. FIG. 2e illustrates an embodiment in which the sealing region 150 extends continuously across the side faces of the open-cell porous body 110 and partially across the bottom face of the open-cell porous body 110. The sealing region 150 in FIG. 2e at least partially extends into the pores 140 of open-cell porous body 110 to restrict the flow of liquid into the respective pores 140 of the open-cell porous body 110. FIG. 2f illustrates an embodiment in which the sealing region 150 is situated within the pores 140 across the side faces of the open-cell porous body 110 and some of the pores 140 across the bottom face of the open-cell porous body 110 in order to restrict the flow of liquid into the respective pores 140 of the open-cell porous body 110. In other embodiments, the sealing region 150 may be situated in only some of the pores 140 across the side faces of the open-cell porous body 110 and some of the pores 140 across the bottom face of the open-cell porous body 110.

In some embodiments, the sealing region 150 forms a liquid impermeable barrier across one or more pores 140 of the open-cell porous body 110. In some embodiments, the sealing region 150 is porous and has a porosity which is lower than the porosity of the open-cell porous body 110, thereby restricting the flow of liquid into the open-cell porous body 110.

The sealing region 150 may comprise one or more of Aluminium Oxide, Silicon Oxide, Magnesium Oxide, Barium Oxide, Calcium Oxide, Zirconium Dioxide or Zinc Oxide.

It will be appreciated that numerous alternative sealing region 150 arrangements or materials may be utilized to restrict the flow of liquid through the open-cell porous body 110 to the heating element 120. The positioning of the sealing region 150 on the open-cell porous body 110 may be adapted to a specific aerosol-generating system in order to effectively control the flow of liquid aerosol-forming substrate through the open-cell porous body 110 to the heating element 120.

Referring to FIGS. 3 and 4, there is shown a schematic illustration of an example aerosol-generating cartridge 400 and a schematic illustration of an example aerosol-generating system 600. The aerosol-generating system 600 comprises two main components, a cartridge 400 and a main body part or aerosol-generating device 500.

The aerosol-generating cartridge 400 comprises: a heater assembly 100, and a liquid storage portion 430, 435 configured to hold a liquid aerosol-forming substrate. The liquid storage portion 430, 435 is arranged at an opposite side of the heater assembly to the porous outer surface.

The aerosol-generating system 600 comprises: a cartridge 400; a power supply 510 for supplying electrical power to the heating element; control circuitry 520 configured to control a supply of power from the power supply 510 to the heating element.

A connection end 415 of the cartridge 400 is removably connected to a corresponding connection end 505 of the aerosol-generating device 500. The connection end 415 of the cartridge 400 and connection end 505 of the aerosol-generating device 500 each have electrical contacts or connections (not shown) which are arranged to cooperate to provide an electrical connection between the cartridge 400 and the aerosol-generating device 500. The aerosol-generating device 500 contains a power source in the form of a battery 510, which in this example is a rechargeable lithium ion battery, and control circuitry 520. The aerosol-generating system is portable and has a size comparable to a conventional cigar or cigarette. A mouthpiece 425 is arranged at the end of the cartridge 400 opposite the connection end 415.

The cartridge 400 comprises a housing 405 containing the heater assembly 100 of FIG. 1a or FIG. 2a-f and a liquid storage compartment or portion having a first storage portion 430 and a second storage portion 435. A liquid aerosol-forming substrate is held in the liquid storage compartment. Although not illustrated in FIG. 3 or 4, the first storage portion 430 of the liquid storage compartment is connected to the second storage portion 435 of the liquid storage compartment so that liquid in the first storage portion 430 can pass to the second storage portion 435. The heater assembly 100 receives liquid from the second storage portion 435 of the liquid storage compartment. At least a portion of the open-cell porous body of the heater assembly 100 extends into the second storage portion 435 of the liquid storage compartment to contact the liquid aerosol-forming substrate therein.

An air flow passage 440, 445 extends through the cartridge 400 from an air inlet 450 formed in a side of the housing 405 past the heating element of the heater assembly 100 and from the heater assembly 100 to a mouthpiece opening 410 formed in the housing 405 at an end of the cartridge 400 opposite to the connection end 415.

The components of the cartridge 400 are arranged so that the first storage portion 430 of the liquid storage compartment is between the heater assembly 100 and the mouthpiece opening 410, and the second storage portion 435 of the liquid storage compartment is positioned on an opposite side of the heater assembly 100 to the mouthpiece opening 410. In other words, the heater assembly 100 lies between the two portions 430, 435 of the liquid storage compartment and receives liquid from the second storage portion 435. The first storage portion 430 of the liquid storage compartment is closer to the mouthpiece opening 410 than the second storage portion 435 of the liquid storage compartment. The air flow passage 440, 445 extends past the heating element of the heater assembly 100 and between the first 430 and second 435 portions of the liquid storage compartment.

The aerosol-generating system is configured so that a negative pressure can be applied at the mouthpiece 425 of the cartridge to draw aerosol out of the mouthpiece opening 410. In operation, when a negative pressure is applied to the mouthpiece 425, air is drawn through the airflow passage 440, 445 from the air inlet 450, past the heater assembly 100, to the mouthpiece opening 410. The control circuitry 520 controls the supply of electrical power from the battery 510 to the cartridge 400 when the system is activated. This in turn controls the amount and properties of the vapour produced by the heater assembly 100. The control circuitry 520 may include an airflow sensor (not shown) and the control circuitry 520 may supply electrical power to the heater assembly 100 when user puffs are detected by the airflow sensor. This type of control arrangement is well established in aerosol-generating systems such as inhalers and e-cigarettes. When a negative pressure is applied to the mouthpiece opening 410 of the cartridge 400, the heater assembly 100 is activated and generates a vapour that is entrained in the air flow passing through the air flow passage 440. The vapour cools within the airflow in passage 445 to form an aerosol, which is then drawn into the user's mouth through the mouthpiece opening 410.

In operation, the mouthpiece opening 410 is typically the highest point of the system. The construction of the cartridge 400, and, in particular, the arrangement of the heater assembly 100 between first and second storage portions 430, 435 of the liquid storage compartment, is advantageous because it exploits gravity to ensure that the liquid substrate is delivered to the heater assembly 100 even as the liquid storage compartment is becoming empty, but prevents an oversupply of liquid to the heater assembly 100 which might lead to leakage of liquid into the air flow passage 440.

For the purpose of the present description and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein. In this context, therefore, a number A is understood as A+10 percent (10%) of A. Within this context, a number A may be considered to include numerical values that are within general standard error for the measurement of the property that the number A modifies. The number A, in some instances as used in the appended claims, may deviate by the percentages enumerated above provided that the amount by which A deviates does not materially affect the basic and novel characteristic(s) of the claimed invention. Also, all ranges include the maximum and minimum points disclosed and include any intermediate ranges therein, which may or may not be specifically enumerated herein.

1.-15. (canceled)

16. A heater assembly for an aerosol-generating device comprising a reservoir configured to hold a liquid aerosol-forming substrate, the heater assembly comprising:
a heating element; and
an open-cell porous body coupled to the heating element,
wherein the open-cell porous body is configured to transport liquid from the reservoir towards the heating element,
wherein the open-cell porous body comprises a sealing region configured to restrict the flow of liquid from the reservoir through the open-cell porous body, and
wherein the open-cell porous body has a liquid absorption side and an aerosolization side, the heating element being disposed along the aerosolization side of the open-cell porous body and the sealing region being disposed along the liquid absorption side of the open-cell porous body such that a rate of liquid absorption through the open-cell porous body is limited.

17. The heater assembly according to claim 16,
wherein the heating element is coupled to a first face of the open-cell porous body and the sealing region extends across at least one other face of the open-cell porous body, and
wherein the at least one other face includes a face opposite the first face.

18. The heater assembly according to claim 16,
wherein the heating element is coupled to a first face of the open-cell porous body and the sealing region extends across at least one other face of the open-cell porous body, and
wherein the at least one other face includes a face adjacent to the first face.

19. The heater assembly according to claim 18,
wherein the open-cell porous body has a cuboidal shape, and
wherein the at least one other face comprises each of the faces adjacent to the first face.

20. The heater assembly according to claim 16, wherein the heating element is coupled to a first face of the open-cell porous body and the sealing region extends across the remaining faces of the open-cell porous body.

21. The heater assembly according to claim 16, wherein the sealing region extends continuously across a face of the open-cell porous body.

22. The heater assembly according to claim 16, wherein the sealing region extends intermittently across a face of the open-cell porous body.

23. The heater assembly according to claim 16, wherein the sealing region at least partially extends into pores of the open-cell porous body.

24. The heater assembly according to claim 16, wherein the sealing region has a thickness no greater than 1 mm.

25. The heater assembly according to claim 16, wherein the sealing region is porous and has a porosity that is lower than a porosity of the open-cell porous body.

26. The heater assembly according to claim 16, wherein the sealing region comprises an inorganic layer deposited across outermost pores of the open-cell porous body.

27. The heater assembly according to claim 16, wherein the sealing region comprises deformed outermost pores of the open-cell porous body.

28. A cartridge comprising the heater assembly according to claim 16 and a reservoir configured to hold a liquid aerosol-forming substrate.

29. An aerosol-generating system comprising the cartridge according to claim 28 and an aerosol-generating device.

30. A method for manufacturing a heater assembly for an aerosol-generating device comprising a reservoir configured to hold a liquid aerosol-forming substrate, the heater assembly comprising a heating element coupled to an open-cell porous body, the method comprising:
applying a sealing region across a face of the open-cell porous body configured to restrict the flow of liquid from the reservoir through the open-cell porous body,
wherein the open-cell porous body has a liquid absorption side and an aerosolization side, the heating element disposed along the aerosolization side of the open-cell porous body and the sealing region disposed along the liquid absorption side of the open-cell porous body such that a rate of liquid absorption through the open-cell porous body is limited.
